(19) United States
(12) Patent Application Publication
(10) Pub. No.: US 2001/0018122 A1
(43) Pub. Date: Aug. 30, 2001

(54) Adhesive composition

(75) Inventors: Masahiro Yuyama, Ibaraki-ken (JP); Hitoshi Arai, Ibaraki-ken (JP); Yoshitsugu Eguchi, Ibaraki-ken (JP)

Correspondence Address: Jules E. Goldberg, Esq., Reed Smith LLP, 17th Floor, 375 Park Avenue, New York, NY, 10152-1799, US

(73) Assignee: Shin-Etsu Chemical Co., Ltd.

(21) Appl. No.: 09/764,979

(22) Filed: Jan. 17, 2001

(30) Foreign Application Priority Data
Jan. 20, 2000 (JP) 2000-011659
Jun. 30, 2000 (JP) 2000-198023

(51) Int. Cl. B32B 7/12

(52) U.S. Cl. 428/343; 428/352; 428/355 EP

(57) ABSTRACT

Disclosed is an improved epoxy resin-based adhesive composition, which is particularly suitable for use in the preparation of a base sheet for flexible printed circuit boards as a laminate of an insulating plastic resin film and a foil of a metal such as copper as well as in the preparation of a coverlay film for protection of the circuit pattern of the metal foil in a flexible printed circuit board. The adhesive composition comprises, as a uniform blend, (a) an epoxy resin, (b) an acrylic rubber modified by carboxyl groups to have a specified content of the carboxyl groups, (c) a curing agent for the epoxy resin such as an aromatic amine compound and (d) a curing promoter, each in a specified weight proportion.

### BACKGROUND OF THE INVENTION

The present invention relates to an adhesive composition or, more particularly, to an epoxy resin-based adhesive composition suitable for use in the preparation of coverlay films and flexible printed circuit boards.

A flexible printed circuit board used in assembly of an electronic instrument is prepared by forming a circuit pattern on a base sheet which is a laminate consisting of an electrically insulating base film and a metal foil with intervention of an adhesive layer and by further laminating the same with another insulating film obtained from a coverlay film by removing the releasable paper sheet for temporary protection.

These flexible printed circuit boards and base sheets therefor should satisfy various requirements for the properties including adhesive strength, heat resistance, solvent resistance, electric properties, dimensional stability, long-term stability against heat, and so on. Further in recent years, along with the trend of circuit boards in general toward higher and higher circuit density and lighter and lighter weight, flexible circuit boards are also required, in addition to the good adhesive strength, to have further improved heat resistance and high flexibility. In particular, one of the serious problems encountered in flexible printed circuit boards is migration of metal forming the metal foil when the circuit board is employed with voltage application in a high-humidity atmosphere at a high temperature resulting in failure of insulation between finely patterned circuit lines.

The adhesives used in the base sheets for flexible printed circuit boards include various combinations of heat-curable resins and flexible resins or elastomers. The adhesive compositions heretofore proposed include combinations of an epoxy resin and NBR, epoxy resin and polyester, epoxy resin and acrylic resin and the like, of which the epoxy resin/NBR adhesive compositions are the most widely employed by virtue of their excellent adhesive strength as compared with the epoxy resin/acrylic resin adhesive compositions.

As is understood, migration of a metal takes place mainly as a consequence of an increase in the impurity ion concentrations in the adhesive composition and thermal degradation of the adhesive resin. Several countermeasures are proposed heretofore for decreasing migration of metals including the use of a high-quality adhesive by using a high-purity epoxy resin (Japanese Patent Kokai 61-221719), purification of the flexibility-imparting polymeric ingredient such as NBRs (Japanese Patent Kokai 7-231162), admixture of the adhesive with an anion adsorbent such as hydrotalcite (Japanese Patent Kokai 10-112576), use of an acrylic resin less susceptible to thermal degraclation (Japanese Patent Kokai 3-255186) and so on.

These countermeasures are, however, practically not quite feasible. For example, polymeric materials of high purity are generally very expensive to be prohibitive against practical use thereof. The effectiveness of the anion adsorbent is rather limited and no sufficient improvement can be obtained unless the amount thereof is unduly increased with sacrifice of peelability and other desirable properties. The epoxy/NBR adhesives, which are excellent in the adhesive strength, sometimes contain a substantial amount of ionic impurities and are subject to undue thermal degradation so that satisfactory prevention against metal migration can hardly be expected therewith. Attempts are being made for the use of an acrylic resin-based adhesive which, however, is not satisfactory due to the relatively low adhesive strength although good solvent resistance can be obtained therewith. Thus, it is eagerly desired to develop an adhesive composition which could satisfy all of the above mentioned various requirements with good balance or, in particular, to develop an adhesive composition which is little susceptible to the undesirable phenomenon of metal migration when the adhesive composition is used for the preparation of flexible printed circuit boards and the like.

### SUMMARY OF THE INVENTION

The present invention accordingly has an object, in view of the above described problems and disadvantages in the conventional adhesive compositions, to provide a novel and improved epoxy resin-based adhesive composition which is imparted with little susceptibility to the phenomenon of metal migration without decreasing the various desirable properties such as excellent solvent resistance, peelability behavior, large curing velocity, high adhesive strength and so on. The invention has a further object to provide a novel and improved base sheet for flexible printed circuit boards and coverlay film prepared by using the above mentioned adhesive composition of the invention.

Thus, the adhesive composition provided by the present invention, which is a uniform blend, comprises:

(a) 100 parts by weight of an epoxy resin;

(b) from 40 to 200 parts by weight of a carboxyl group-modified acrylic rubber, of which the content of the carboxyl groups is in the range from 0.05 to 2% by weight;

(c) from 1 to 50 parts by weight of a curing agent for the epoxy resin; and

(d) from 0.1 to 5 parts by weight of a curing promoter selected from the group consisting of tertiary amine salts of a tetraphenylboron-based acid, borofluoride compounds and metal octoates.

The coverlay film of the present invention is a laminated sheet material comprising an electrically insulating base film and a releasable protective sheet attached to the base film with intervention of a semi-cured layer of the above defined adhesive composition. The base sheet for a flexible printed circuit board of the invention is a laminated sheet material comprising an electrically insulating flexible plastic resin film and a metal foil attached to the flexible plastic resin film with intervention of a cured layer of the above defined adhesive composition.

### DETAILED DESCRIPTION OF THE PREFERRED EMBODIMENTS

The epoxy resin as the component (a) in the inventive adhesive composition is a polyfunctional epoxy resin having at least two epoxy groups in a molecule. Several different types of epoxy resins are suitable for the purpose including bisphenol A-based epoxy resins, bisphenol F-based epoxy resins, bisphenol novolak-based epoxy resins, alicyclic epoxy resins and glycidylamine-based epoxy resins as well as halogen-modified epoxy resins derived therefrom. A variety of commercial products of these epoxy resins are available on the market and can be used as such in the present invention including, for example, those sold under the trade names of Epikotes 828, 154, 604, 871, 1001,152, 5050, 5048, 5049 and 5045 (each a product by Yuka Shell Epoxy Co.), BREN-S (a product by Nippon Kayaku Co.) and EP 410 (a product by Asahi Denka Co.).

The component (b) in the inventive adhesive composition is a carboxyl group-modified acrylic rubber, of which the content of the carboxyl groups is in the range from 0.05 to 2% by weight or, preferably, from 0.05 to 1.8% by weight. Examples of suitable carboxyl-modified acrylic rubbers include acrylic rubbers of which each molecular chain terminal is blocked with a carboxyl group and copolymeric acrylic rubbers obtained by the copolymerization of a monomer mixture including a monomeric compound having a carboxyl group in the molecule. When the content of the carboxyl groups is too low, the adhesive composition cannot be imparted with good solvent resistance while, when the content of the carboxyl groups is too high, sufficient improvement cannot be obtained with the adhesive composition relative to retention of adhesive strength, resistance against migration of metals and peeling resistance.

The amount of the carboxyl-modified acrylic rubber as the component (b) in the inventive adhesive composition is in the range from 40 to 200 parts by weight or, preferably, from 50 to 140 parts by weight per 100 parts by weight of the epoxy resin as the component (a). When the amount thereof is too small, the adhesion strength of the adhesive composition cannot be high enough while, when the amount is too large, curing of the adhesive composition cannot be complete due to a decrease in the curing velocity so that the adhesive composition after curing cannot be imparted with good solvent resistance.

Several commercial products are available on the market as a carboxyl-modified acrylic rubber suitable for use as the component (b) in the inventive adhesive composition including those sold under the trade names of NSA-04 (a product by Nisshin Chemical Industry Co.) and others. These carboxyl-modified acrylic rubbers can be used either singly or as a combination of two kinds or more according to need. It is optional that the carboxyl-modified acrylic rubber is used in combination with an epoxy-modified acrylic rubber in a limited proportion.

The third essential ingredient, i.e. the component (c), in the inventive adhesive composition is a curing agent for the epoxy resin ;as the component (a). Various known curing agents for epoxy resins can be used here including aliphatic amine compounds, alicyclic amine compounds, aromatic amine compounds, acid anhydride compounds, dicyandiamide, boron trifluoride and the like. Selection of the curing agent is important because the phenomenon of metal migration is greatly influenced by the types of the curing agent. For example, the insusceptibility to the phenomenon of metal migration is adversely affected when an amine compound having high activity, such as aliphatic and alicyclic amine compounds, is used as the curing agent. In this regard, it is preferable that the curing agent is an aromatic amine compound such as 4,4′-diaminodiphenyl sulfone and 3,3′-diaminodiphenyl sulfone. The compounding amount of the curing agent as the component (c) in the inventive adhesive composition is in the range from 1 to 50 parts by weight or, preferably, from 5 to 20 parts by weight per 100 parts by weight of the epoxy resin as the component (a). When the amount of the curing agent is too small, full curing of the epoxy resin cannot be accomplished as a matter of course adversely affecting the insusceptibility of the adhesive composition to the phenomenon of metal migration along with a decrease in other desirable properties such as solvent resistance and electric properties while, when the amount is too large, a decrease is resulted in the adhesive strength and heat resistance to withstand soldering.

The fourth essential ingredient, i.e. component (d), is a curing promoter which can be selected from the group consisting of tertiary amine salts of a tetraphenylboron-containing acid, borofluoride compounds such as zinc borofluoride, tin borofluoride and nickel borofluoride and metal octoate salts such as tin octoate and zinc octoate. These compounds can be used either singly or as a combination of two kinds or more according to need as the curing promoter. The compounding amount of the curing promoter as the component (d) in the inventive adhesive composition is in the range from 0.1 to 5 parts by weight or, preferably, from 0.5 to 2.5 parts by weight per 100 parts by weight of the epoxy resin as the component (a). When the compounding amount of the curing promoter is too small, the curing velocity of the epoxy resin cannot be high enough and curing of the epoxy resin is sometimes incomplete resulting in a decrease in he insusceptibility to the phenomenon of metal migration, electric properties and solvent resistance while, when the amount is too large, a decrease is caused in the storage stability or pot life of the adhesive composition adversely affecting the workability along with a decrease in the adhesive strength and heat resistance to withstand soldering.

It is of course optional that the inventive adhesive composition is admixed with resinous ingredients of other types and known additives conventionally employed in adhesive compositions each in a limited amount including phenolic resins as an auxiliary resinous ingredient and halogenated organic compounds, antimony trioxide, aluminum hydroxide and silicon dioxide as a flame retardant agent.

It is usually convenient that the inventive adhesive composition comprising the above described essential ingredients, i.e. components (a) to (d), and some optional ingredients is used as diluted with an organic solvent to have a consistency or viscosity suitable for the application works. The organic solvent used in this purpose is selected from the group consisting of methanol, ethanol, isopropyl alcohol, acetone, methyl ethyl ketone, toluene, trichloroethylene, 1,4-dioxane, 1,3-dioxane and dioxolan, though not particularly limitative thereto. These organic solvents can be used either singly or as a mixture of two kinds or more according to need.

The amount of the organic solvent to dilute the inventive adhesive composition naturally depends on the desired consistency or viscosity of the diluted composition suitable for the particular application works. Generally, the amount of the organic solvent for dilution should be such that the solid content of the diluted adhesive composition is in the range from 10 to 45% by weight or, for most applications, from 20 to 35% by weight. When the solid content of the diluted adhesive composition is too high, the workability with the composition is decreased due to an unduly high viscosity while, when the solid content is too low, the viscosity of the diluted composition is so low that unevenness is eventually caused in the adhesive coating layer if not to mention the economical disadvantage and environmental pollution due to a large volume of solvent vapor emission to the ambience. Mixing of the ingredients to prepare the adhesive composition can be performed by using a mixing machine such as pot mills, ball mills, roll mills, homogenizers, super mills and the like.

In the preparation of a coverlay film or a base sheet for flexible printed circuit boards, the above described inventive adhesive composition is uniformly applied to the surface of an electrically insulating film of a plastic resin such as a polyimide resin, polyester resin, poly(parabanic acid) resin, polyphenylenesulfide resin and aramid resin, of which polyimide resins are preferable. The thickness of the plastic resin film should naturally be selected depending on the particularly intended application of the final product but, generally, the film has a thickness in the range from 10 to 125 μm. It is optional that the plastic resin film before application of the adhesive composition is subjected to a surface treatment on a single surface or on both surfaces by the method of low-temperature plasma treatment, corona discharge treatment or sand blasting treatment.

The base sheet for flexible printed circuit boards according to the invention is prepared by adhesively bonding a metal foil to the adhesive-coated surface of a plastic resin film mentioned above. The metal foil can be a copper foil, aluminum foil or iron foil, though not particularly limitative thereto, of which copper foils are preferred for most applications. The thickness of the metal foil, which is selected naturally depending on the intended application of the product, is usually in the range from 5 to 70 μm.

Following is a description of the preparation procedure of the base sheet for flexible printed circuit boards. Thus, an electrically insulating plastic resin film is uniformly coated with the adhesive composition of the invention as diluted with an organic solvent by using a suitable coating machine such as a reverse coater followed by a heat treatment in an oven at a temperature of 80 to 140° C. for 2 to 10 minutes to effect evaporation of the organic solvent and semi-curing of the adhesive composition. The thus dried adhesive layer has a thickness in the range from 5 to 45 μm or, preferably, from 5 to 30 μm. Lamination of a metal foil to the thus adhesive-coated surface of the plastic resin film is performed by using a hot roller at a temperature of 60 to 150° C. under a linear roll pressure of 2 to 200 N/cm followed, if necessary, by a heat treatment of the laminate in an oven at 80 to 200° C. for 1 minute to 24 hours to effect complete curing of the adhesive composition.

As is described before, a coverlay film is an electrically insulating plastic resin film provided on one surface with a layer of a semi-cured adhesive composition and the semi-cured adhesive layer is temporarily protected by attaching a releasable paper sheet which is removed before use of the adhesive-coated plastic resin film by lamination for protection of the circuit pattern on a flexible printed circuit board prepared by using the base sheet of flexible printed circuit boards described above. Namely, a flexible printed circuit board is completed only by lamination of a coverlay film for protection of the printed circuit pattern.

The electrically insulating plastic resin film as the base of the above mentioned coverlay film can be the same one as that used in the preparation of the base sheet for flexible printed circuit boards. The releasable paper sheet for temporary protection of the semi-cured adhesive-coated surface of the coverlay film is a base paper sheet laminated on one or both of the surfaces with a thin film of a resin such as polyethylene, poly(4-methylpentene-1), referred to as TPX hereinafter, polypropylene, polyvinylidene chloride and the like or coated with these resins, optionally, after a surface treatment with a silicone-based releasing agent. A releasable paper sheet prepared by laminating a TPX film onto one or both of the surfaces of a base paper sheet is particularly preferred. The TPX film has a thickness in the range from 5 to 50 μm. When the thickness of the TPX film is too small, the laminated releasable paper sheet is poor in the workability for a punching work due to the deficiency in the effect of stiffness to be imparted by the TPX film while, when the thickness thereof is too large, the releasable paper sheet is too stiff resulting in a decrease of the durability of punches and dice for the punching works.

The coverlay film according to the invention is prepared by coating an electrically insulating plastic resin film with a solution of the inventive adhesive composition in an organic solvent in a coating amount to give a thickness of the adhesive layer after drying in the range from 10 to 60 μm followed by a heat treatment, for example, at about 100° C. to remove the solvent by evaporation and to bring the adhesive composition into a semi-cured state. The adhesive-coated plastic resin film is then laminated with the releasable paper sheet for temporary protection of the semi-cured adhesive layer by using a suitable laminating machine such as a roller laminater at a temperature of 20 to 100° C. under a linear roll pressure of 2 to 200 N/cm into a roll of a continuous-length coverlay film.

In the following, the present invention is described in more detail by way of Examples and Comparative Examples, which, however, never limit the scope of the invention in any way.

### EXAMPLE 1

An adhesive composition in the form of a solution was prepared by uniformly dissolving or dispersing, in 665 g of methyl ethyl ketone, 100 g of an epoxy resin having an epoxy equivalent of 395 g/mole (Epikote 5050, a product by Yuka Shell Epoxy Co.), 100 g of a carboxyl-modified acrylic rubber (NSA-04, a product by Nisshin Chemical Industry Co.) containing 1.6% by weight of the carboxyl groups, 10 g of 4,4′-diaminodiphenyl methane, referred to as DDM hereinafter, 2 g of tin octoate and 10 g of aluminum hydroxide. The solid content of this adhesive solution was about 25% by weight.

A 200 mm by 200 mm wide polyimide resin film of 25 μm thickness (Capton, a product by Toray Du Pont Co.) was coated with the adhesive solution by using an applicator in such a coating amount as to give a dried adhesive layer of 20 μm thickness followed by a heat treatment at 120° C. for 10 minutes to evaporate the solvent and to bring the adhesive layer into a semi-cured state. The thus obtained polyimide resin film having a semi-cured adhesive layer was laminated with a 200 mm by 200 mm wide rolled copper foil of 35 μm thickness (BHN, a product by Japan Energy Co.) by using a press at 160° C. for 30 minutes under a linear roll pressure of 100 N/cm followed by a further heat treatment of the laminate in an oven at 170° C. for 3 hours to effect complete curing of the adhesive composition thus giving a base sheet for flexible printed circuit boards which was subjected to evaluation tests for the following testing items by the respective testing procedures described there. The results obtained by the evaluation tests are shown in Table 1 below.

Testing items and testing procedures

(1) Peeling resistance: Measurements were performed according to the procedure specified in JIS C6481 in which a 1 mm wide strip was prepared by slitting the sample sheet and the copper foil of the strip was peeled by pulling in a 90° direction at a pulling velocity of 50 mm/minute to record the peeling resistance in N/cm.

(2) Solvent resistance: A 1 mm wide strip of the sample sheet after immersion in toluene at 70° C. for 10 minutes was taken out of the toluene bath and immediately subjected to the peeling resistance test in the same manner as in (1) above.

(3) Heat resistance to withstand soldering: Measurements were made according to the testing procedure specified in JIS C6481 in which 25 mm square sample sheets were put each on the melts of a solder alloy at several different temperatures to float thereon for 30 seconds and the highest temperature of the melt at which no blistering or lifting of the copper foil was detected was recorded.

(4) Pot life of the adhesive solution: The adhesive solution after 1 hour of standing at room temperature from preparation was applied to the surface of a plastic resin film to detect occurrence of any unevenly coated areas. The results were recorded as Good or Poor.

(5) Insusceptibility to metal migration: The copper foil of the sample sheet was patterned in a comb-formed pattern with teeth intervals of 100 μm and kept in an atmosphere of 85% relative humidity at 130° C. for 250 hours with application of a DC voltage of 100 volts between the comb teeth. The sample sheet was inspected under a magnifying glass before and after this voltage-application test to detect occurrence of metal migration between the comb teeth. The results were recorded in three ratings of A, B and C with the criteria of A for absence of noticeable metal deposition between comb teeth, B for occurrence of metal deposition but not to an extent of bridging between the comb teeth and C for occurrence of metal migration to bridge between comb teeth.

### EXAMPLE 2

An adhesive solution was prepared in about the same manner as in Example 1 from 100 g of an epoxy resin of another grade having an epoxy equivalent of 475 g/mole (Epikote 5045, a product by Yuika Shell Epoxy Co.), 60 g of the same carboxyl-modified acrylic rubber as used in Example 1 (NSA-04, supra), 10 g of 4,4′-diaminodiphenyl sulfone, referred to as DDS hereinafter, 1.5 g of tin octoate, 10 g of aluminum hydroxide and 665 g of methyl ethyl ketone. The results of the evaluation tests for this adhesive solution undertaken in the same manner as in Example 1 are shown in Table 1 below.

### EXAMPLE 3

An adhesive solution was prepared in about the same manner as in Example 1 from 100 g of an epoxy resin of a further different grade having an epoxy equivalent of 284 g/mole (BREN-S, a product by Nippon Kayaku Co.), 120 g of the same carboxyl-modified acrylic rubber as used in Example 1 (NSA-04, supra), 12 g of DDS, 1.5 g of tin borofluoride Sn(BF₄)₂, 10 g of aluminum hydroxide and 665 g of methyl ethyl ketone. The results of the evaluation tests for this adhesive solution undertaken in the same manner as in Example 1 are shown in Table 1 below.

### EXAMPLE 4

An adhesive solution was prepared in about the same manner as in Example 1 from 100 g of the same epoxy resin as used in Example 2 (Epikote 5045, supra), 100 g of the same carboxyl-modified acrylic rubber (NS-04, supra), 15 g of hexamethylene diamine, 1.5 g of tin borofluoride Sn(BF₄)₂, 10 g of aluminum hydroxide and 665 g of methyl ethyl ketone. The results of the evaluation tests for this adhesive solution undertaken in the same manner as in Example 1 are shown in Table 1 below.

### EXAMPLE 5

An adhesive solution was prepared in about the same manner as in Example 1 from 100 g of the same epoxy resin as used in Example 1 (Epikote 5050, supra), 60 g of the same carboxyl-modified acrylic rubber as used in Example 1 (NSA-04, supra), 7 g of DDS, 1.0 g of tin octoate, 10 g of aluminum hydroxide and 665 g of methyl ethyl ketone.

A coverlay film was prepared by uniformly coating a 200 mm by 200 mm square polyimide resin film of 25 μm thickness (Capton, supra) with the above prepared adhesive solution by using an applicator followed by a heat treatment at 80° C. for 10 minutes to give a dried and semi-cured adhesive layer of 30 μm thickness. This cover-lay film was laminated with the same copper foil as used in Example 1, the glossy surface of the copper foil being in contact with the adhesive surface, by pressing at 160° C. for 30 minutes under a pressure of 9 MPa to give a sample sheet for the evaluation tests undertaken in the same manner as in Example 1. The results of the evaluation tests for this sample sheet are shown in Table 1 below.

### COMPARATIVE EXAMPLE 1

An adhesive solution was prepared in about the same manner as in Example 1 from 100 g of the same epoxy resin as used in Example 1 (Epikote 5050, supra), 250 g of the same carboxyl-modified acrylic rubber as used in Example 1 (NSA-04, supra) 10 g of DDS, 2.0 g of tin octoate, 10 g of aluminum hydroxide and 665 g of methyl ethyl ketone. The results of the evaluation tests for this adhesive solution undertaken in the same manner as in Example 1 are shown in Table 1 below.

### COMPARATIVE EXAMPLE 2

An adhesive solution was prepared in about the same manner as in Example 1 from 100 g of the same epoxy resin Epikote 5050, 30 g of the same carboxyl-modified acrylic rubber NSA-04, 15 g of DDS, 2.0 g of tin octoate, 10 g of aluminum hydroxide and 665 g of methyl ethyl ketone. The results of the evaluation tests for this adhesive solution undertaken in the same manner as in Example 1 are shown in Table 1 below.

### COMPARATIVE EXAMPLE 3

An adhesive solution was prepared in about the same manner as in Example 1 from 100 g of the same epoxy resin as in Example 3 (BREN-S, supra), 60 g of an acrylic rubber AR-31 free from carboxyl groups, 12 g of DDM, 1.5 g of tin borofluoride, 10 g of aluminum hydroxide and 665 g of methyl ethyl ketone. The results of the evaluation tests for this adhesive solution undertaken in the same manner as in Example 1 are shown in Table 1 below.

### COMPARATIVE EXAMPLE 4

An adhesive solution was prepared in about the same manner as in Example 1 from 100 g of the same epoxy resin as used in Example 2 (Epikote 5045, supra), 70 g of a carboxyl-modified acrylic rubber of another grade containing 3.1% by weight of carboxyl groups (NSA-02, a product by Nisshin Chemical Industry Co.), 15 g of DDM, 1.0 g of tin borofluoride, 10 g of aluminum hydroxide and 665 g of methyl ethyl ketone. The results of the evaluation tests for this adhesive solution undertaken in the same manner as in Example 1 are shown in Table 1 below.

### COMPARATIVE EXAMPLE 5

An adhesive solution was prepared in about the same manner as in Example 1 from 100 g of the same epoxy resin as used in Example 2 (Epikote 5045, supra), 50 g of the same carboxyl-modified acrylic rubber (NSA-04, a product by Nissin Chemical Industry Co.), 55 g of DDS, 2.0 g of tin octoate, 10 g of aluminum hydroxide and 665 g of methyl ethyl ketone. The results of the evaluation tests for this adhesive solution undertaken in the same manner as in Example 1 are shown in Table 1 below.

### COMPARATIVE EXAMPLE 6

An adhesive solution was prepared in about the same manner as in Example 1 from 100 g of the same epoxy resin as used in Example 2 (Epikote 5045, supra), 80 g of the same carboxyl-modified acrylic rubber as used in Example 1 (NSA-04, supra), 20 g of DDM, 20 g of tin borofluoride, 10 g of aluminum hydroxide and 665 g of methyl ethyl ketone. The results of the evaluation tests for this adhesive solution undertaken in the same manner as in Example 1 are shown in Table 1 below.

TABLE 1

| | Peeling | Solvent | Heat | | |
|---|---|---|---|---|---|
| | resistance, | resistance, | resistance, | | Metal |
| | N/cm | N/cm | ° C. | Pot life | migration |
| Example 1 | 12 | 5 | 330 | Good | A |
| Example 2 | 10 | 5 | 330 | Good | A |
| Example 3 | 10 | 4 | 330 | Good | A |
| Example 4 | 8 | 4 | 330 | Good | A |
| Example 5 | 9 | 4 | 330 | Good | A |
| Comparative | 10 | 2 | 330 | Poor | B |
| Example 1 | | | | | |
| Comparative | 5 | 4 | 330 | Good | B |
| Example 2 | | | | | |
| Comparative | 12 | 2 | 330 | Poor | A |
| Example 3 | | | | | |
| Comparative | 9 | 5 | 330 | Poor | B |
| Example 4 | | | | | |
| Comparative | 4 | 3 | 310 | Poor | C |
| Example 5 | | | | | |
| Comparative | 3 | 2 | 320 | Poor | C |
| Example 6 | | | | | |

What is claimed is:

1. An adhesive composition as a uniform blend which comprises:
(a) 100 parts by weight of an epoxy resin having at least two epoxy groups in a molecule;
(b) from 40 to 200 parts by weight of a carboxyl group-modified acrylic rubber, of which the content of the carboxyl groups is in the range from 0.05 to 2% by weight;
(c) from 1 to 50 parts by weight of a curing agent for the epoxy resin; and
(d) from 0.1 to 5 parts by weight of a curing promoter selected from the group consisting of tertiary amine salts of a tetraphenylboron-based acid, borofluoride compounds and metal octoates.

2. The adhesive composition as claimed in claim 1 in which the content of the carboxyl groups in the carboxyl group-modified acrylic rubber as the component (b) is in the range from 0.05 to 1.8% by weight.

3. The adhesive composition as claimed in claim 1 in which the amount of the carboxyl group-modified acrylic rubber as the component (b) is in the range from 50 to 140 parts by weight per 100 parts by weight of the epoxy resin as the component (a).

4. The adhesive composition as claimed in claim 1 in which the curing agent for the epoxy resin as the component (c) is selected from the group consisting of aliphatic amine compounds, alicyclic amine compounds, aromatic amine compounds, dicyandiamide and complexes of an amine and boron trifluoride.

5. The adhesive composition as claimed in claim 4 in which the curing agent for the epoxy resin as the component (c) is an aromatic amine compound.

6. The adhesive composition as claimed in claim 1 in which the amount of the curing agent for the epoxy resin as the component (c) is in the range from 5 to 20 parts by weight per 100 parts by weight of the epoxy resin as the component (a).

7. The adhesive composition as claimed in claim 1 in which the amount of the curing promoter as the component (d) is in the range from 0.5 to 2.5 parts by weight per 100 parts by weight of the epoxy resin as the component (a).

8. A coverlay film which is a layered sheet material comprising an electrically insulating base sheet and a releasable paper sheet attached to one of the surfaces of the base sheet with intervention of a layer of the adhesive composition defined in claim 1.

9. A base sheet for a flexible printed circuit board which is a laminated sheet material comprising an electrically insulating flexible film and a metal foil adhesively bonded to one of the surfaces of the electrically insulating flexible film with intervention of a cured layer of the adhesive composition defined in claim 1.
